(19) United States
(12) Patent Application Publication
(10) Pub. No.: US 2005/0153191 A1
(43) Pub. Date: Jul. 14, 2005

(54) Fuel cell

(75) Inventors: Noriyuki Suzuki, Tokyo (JP); Harutsugu Aimura, Tokyo (JP); Tomoo Joke, Kawasaki-shi (JP); Shoji Ihara, Yokohama-shi (JP); Masahiro Suzuki, Kawasaki-shi (JP); Yasuhiko Ishida, Tokyo (JP); Makoto Handa, Chigasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/025,980

(22) Filed: Jan. 3, 2005

(30) Foreign Application Priority Data
Jan. 8, 2004 (JP) 2004-003302

(51) Int. Cl. H01M 8/04

(52) U.S. Cl. 429/34; 429/38

(57) ABSTRACT

There is provided a fuel cell, including: a fuel receiving portion for receiving a fuel; a reaction portion for carrying out an electricity generation reaction using the fuel; and a waste water receiving portion for receiving water as a by-product of the electricity generation reaction, in which at least part of the waste water receiving portion has a confirmation window constructed of a transparent member. The fuel cell of the present invention allows detection of a remaining volume of a fuel at a high level of visibility without providing special detection means.

### BACKGROUND OF THE INVENTION

1. Field of the Invention

The present invention relates to a fuel cell, and more specifically to a fuel cell having a fuel receiving cartridge.

2. Related Background Art

A fuel cell constructed of a detachable fuel receiving cartridge has been heretofore contrived to facilitate fuel refill. For example, Japanese Patent Application Laid-Open No. 2002-169625 discloses a fuel cell constructed of an electricity generating cell portion, and a fuel tank and a waste water tank which are detachable from the electricity generating cell. In Japanese Patent Application Laid-Open No. 2002-169625, a fuel tank is constructed of a transparent member allowing visual observation of a remaining volume of methanol used as a fuel.

Further, Japanese Patent Application Laid-Open No. 2002-289210 discloses a fuel cell constructed of an electricity generating module and a fuel pack detachable from the electricity generating module. The fuel cell has substantially the same shape as that of an existing chemical cell. Japanese Patent Application Laid-Open No. 2002-289210 describes that a remaining volume of a fuel is detected by measuring a liquid level of the fuel or a transmittance through the fuel in the fuel pack using an optical sensor.

In Japanese Patent Application Laid-Open No. 2002-289210, the remaining volume of the fuel is detected by using special detection means (optical sensor). Such special means not only causes cost increase, but also requires electrical power for detecting the remaining volume of the fuel. Thus, when the fuel becomes completely empty, that is, when supply of electrical power from the fuel cell stops, a problem develops in that the crucial remaining volume cannot be detected. In other words, whether an operation stops because an apparatus runs out of fuel or because of other reasons cannot be specified. Electrical power for detecting the remaining volume of the fuel may be supplied from a chemical fuel or the like other than the fuel cell. However, such a constitution is more complex and inhibits miniaturization of an apparatus and cost reduction.

Further, in Japanese Patent Application Laid-Open No. 2002-169625, the fuel cell has a constitution allowing visual observation of the remaining volume of the fuel without providing special detection means. However, the constitution has a problem in that a transparent methanol fuel is visually observed through a transparent member, and thus, a visibility thereof is very poor.

### SUMMARY OF THE INVENTION

The present invention has been made in view of the problems of the prior art, and an object of the present invention is therefore to provide a fuel cell having a fuel receiving cartridge and allowing detection of a remaining volume of a fuel at a high level of visibility without providing special detection means.

That is, the present invention provides a fuel cell, including: a fuel receiving portion for receiving a fuel; a reaction portion for carrying out an electricity generation reaction using the fuel; and a waste water receiving portion for receiving water as a by-product of the electricity generation reaction, in which at least part of the waste water receiving portion is constructed of a transparent member.

A capacity of the waste water receiving portion is preferably substantially the same as a volume of water formed in the reaction of all fuel received in the fuel receiving portion.

A remaining volume of the fuel received in the fuel receiving portion is preferably determined by measuring a volume of water in the waste water receiving portion.

A coloring substance for coloring water is preferably included inside the waste water receiving portion in advance.

The fuel receiving portion and the waste water receiving portion are preferably constructed integrally and detachably.

In the present invention, water as a by-product of the electricity generation reaction is also referred to as waste water, and the waste water is received in the waste water receiving portion.

According to the present invention, at least part of the waste water receiving portion for collecting waste water, which is a by-product of the electricity generation reaction, is constructed of a transparent member, and a coloring substance for coloring the waste water is included in the waste water receiving portion in advance. Thus, a remaining capacity of a fuel cell (equivalent to a remaining volume of a fuel) can be visually observed assuredly by observing a volume of an aqueous solution in the waste water receiving portion. That is, the present invention can provide a fuel cell allowing detection of a remaining volume of a fuel at a high level of visibility without providing special detection means.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 shows a schematic diagram of a system equipped with a fuel cell according to the present invention;

FIG. 2 shows a schematic diagram of a constitution of a fuel cell according to the present invention;

FIG. 3 shows an external view of a fuel cell according to the present invention; and

FIG. 4 shows an external view of a fuel cell according to the present invention.

### DESCRIPTION OF THE PREFERRED EMBODIMENTS

A fuel cell of the present invention includes: a fuel receiving portion for receiving a fuel; a reaction portion for carrying out an electricity generation reaction using the fuel; and a waste water receiving portion for receiving water (waste water) as a by-product of the electricity generation reaction, in which: at least part of the waste water receiving portion is constructed of a transparent member; and a coloring substance for coloring the waste water is included inside the waste water receiving portion in advance.

The fuel receiving portion and the waste water receiving portion are constructed integrally in the fuel cell, and the integrated portion is detachable from the reaction portion.

Thus, the fuel cell of the present invention allows assured visual observation of a remaining capacity of a fuel cell (equivalent to a remaining volume of a fuel) by observing a volume of an aqueous solution in the waste water receiving portion and allows detection of a remaining volume of a fuel at a high level of visibility without providing special detection means.

In this case, the remaining volume of the fuel of the fuel cell is confirmed by using waste water which has been simply collected or disposed conventionally, and thus, an electricity generation action (electrochemical reaction) itself is not affected at all. In addition, the fuel receiving portion and the waste water receiving portion are integrally constructed as a fuel cartridge, and the fuel cartridge is detachable from the reaction portion (electricity generating cell portion). Thus, the waste water receiving portion along with the fuel receiving portion can be changed as an integrated fuel cartridge.

In the present invention, methanol, a methanol aqueous solution, liquid hydrogen, or an arbitrary liquid or liquefied substance containing other hydrogen components can be used as the fuel, for example.

The coloring substance may be a substance capable of coloring a liquid fuel, and examples thereof include dyes, pigments, and organic pigments.

A metal, glass, a polymeric resin member (mold member), or the like can be used for the waste water receiving portion. Transparent glass, a transparent polymeric resin member (mold member), or the like can be used for the transparent member constituting at least part of the waste water receiving portion. In the present invention, the term “transparent” refers to a state of at least a transparency level allowing a rough observation of a liquid volume (that is, a remaining volume of waste water) in the waste water receiving portion with a naked eye.

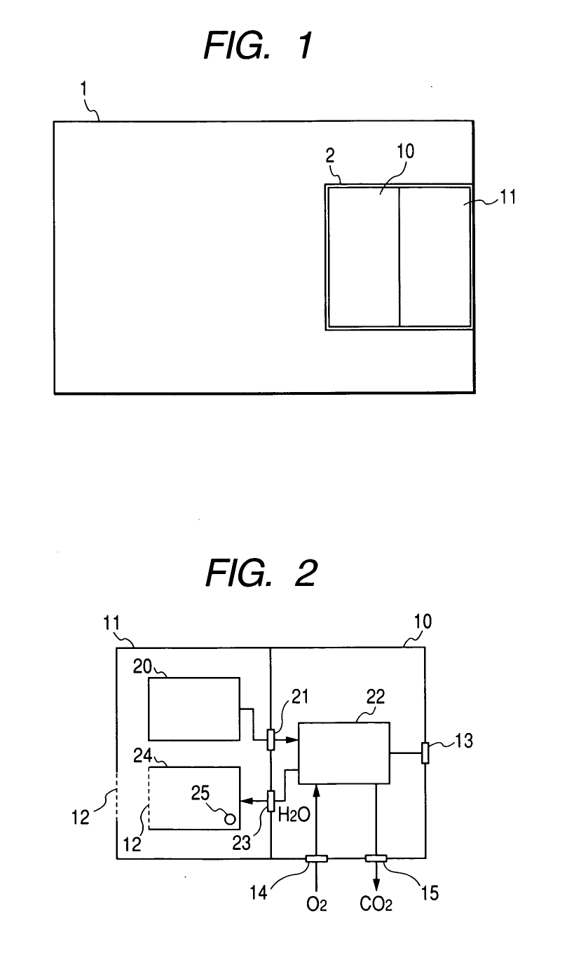

FIG. 1 shows a schematic diagram of a system equipped with a fuel cell according to the present invention.

In FIG. 1, electronic equipment 1 such as a laptop personal computer has a fuel cell 2 of a detachable structure received therein. The fuel cell 2 is divided into an electricity generating cell portion 10 and a fuel cartridge 11, and the electricity generating cell portion 10 and the fuel cartridge 11 each also have a detachable structure. Thus, a user may detach the entire fuel cell 2 or only the fuel cartridge 11 (that is, to change) while the electricity generating cell portion 10 is received in the electronic equipment.

FIG. 2 shows a schematic diagram of a constitution of the fuel cell according to the present invention. In FIG. 2, a fuel tank 20 has a fuel (to be specific, methanol) received. The fuel passes through a fuel supply port 21 and reaches a reaction portion 22. The reaction portion 22 is constructed of a fuel electrode and an air electrode each having a catalyst fine particle adhered thereon and an ion conducting membrane attached between both the electrodes. Electricity generation is carried out through a known electrochemical reaction. Generated electrical power is supplied into the electronic equipment 1 described in FIG. 1 through an electrical contact 13. Reference numeral 11 represents the fuel cartridge.

The electricity generating cell portion 10 is provided with an intake port 14 and an exhaust port 15. Oxygen (O₂) from air is taken in through the intake port 14, and carbon dioxide (CO₂) as a by-product formed as a result of the electrochemical reaction is discharged through the exhaust port 15. Water (H₂O) as a by-product is collected in a waste water tank 24 through a waste water port 23.

The waste water tank 24 has a capacity which is substantially filled by by-product water when the fuel in the fuel tank 20 is used up. In addition, an arbitrary coloring substance (water soluble dye or the like) 25 for coloring the waste water is included inside the waste water tank 24 in advance in a form of a powder, tablet, or the like, or in a form of the powder, tablet, or the like included in a tea bag-like bag container. One end surface of the waste water tank 24 is constructed of a transparent member, and a confirmation window 12 composed of the transparent member allows visual observation of a collected volume of waste water. That is, the waste water is observed by a user at a high level of visibility in the form of an arbitrarily colored aqueous solution and not of transparent water.

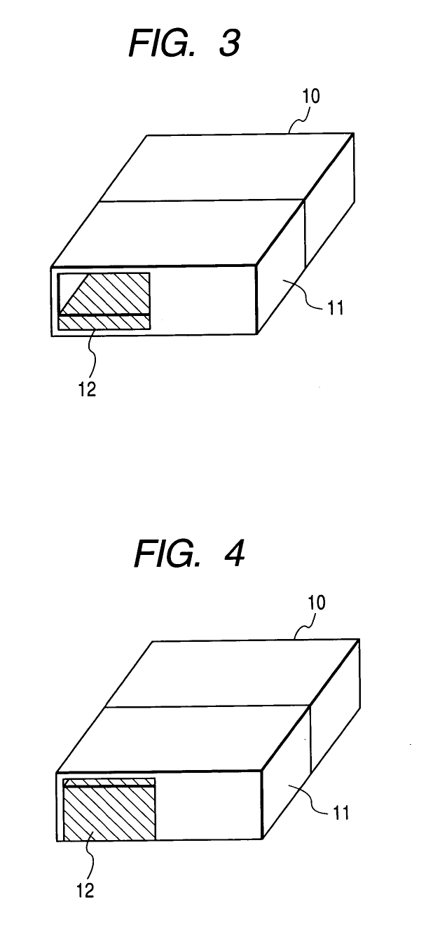

FIGS. 3 and 4 each show an external view of the fuel cell according to the present invention. The same reference characters as those of FIGS. 1 and 2 designate the same members. A volume of the waste water collected in initial use of the fuel cell is small, and a liquid level of the aqueous solution is at a low position (see the external view of FIG. 3). However, a volume of the waste water collected by the time the fuel is used up is close to a full capacity of the waste water tank, and a liquid level of the aqueous solution is at a high position (see the external view of FIG. 4). That is, a remaining capacity of the fuel cell (equivalent to a remaining volume of a fuel) can be confirmed by the liquid level observed in the confirmation window 12.

That is, through measurement of a volume of waste water as shown in FIGS. 3 and 4, a state of FIG. 3 indicates a large remaining volume of the fuel in the fuel receiving portion and a state of FIG. 4 indicates a small remaining volume of the fuel in the fuel receiving portion. In the above-mentioned embodiments, the case of using methanol as a fuel was described as an example. However, the present invention is not limited thereto and may be applied to a case of using hydrogen itself (including a case of storing hydrogen in a hydrogen storage alloy), another liquid fuel or liquefied fuel containing a hydrogen component, or the like as a fuel.

The fuel cell of the present invention has at least part of the waste water portion for collecting waste water as a by-product of the electricity generation reaction constructed of a transparent member, and has a coloring substance for coloring the waste water included in the waste water receiving portion in advance. Thus, a remaining capacity of a fuel cell (equivalent to a remaining volume of a fuel) can be visually observed assuredly by observing a volume of an aqueous solution in the waste water receiving portion. Further, the fuel cell of the present invention allows detection of a remaining volume of a fuel at a high level of visibility without providing special detection means, and thus can be used as a fuel cell for electronic equipment such as a laptop personal computer.

This application claims priority from Japanese Patent Application No. 2004-003302 filed Jan. 8, 2004, which is hereby incorporated by reference herein.

1. A fuel cell comprising:
a fuel receiving portion for receiving a fuel;
a reaction portion for carrying out an electricity generation reaction using the fuel; and
a waste water receiving portion for receiving water as a by-product of the electricity generation reaction, wherein
at least part of the waste water receiving portion is constructed of a transparent member.

2. The fuel cell according to claim 1, wherein a capacity of the waste water receiving portion is substantially the same as a volume of water formed in the reaction of all fuel received in the fuel receiving portion.

3. The fuel cell according to claim 1, wherein a remaining volume of the fuel received in the fuel receiving portion is determined by measuring a volume of water in the waste water receiving portion.

4. The fuel cell according to claim 1, wherein a coloring substance for coloring water is included inside the waste water receiving portion in advance.

5. The fuel cell according to claim 1, wherein the fuel receiving portion and the waste water receiving portion are integrally and detachably constructed.
